(19) United States
(12) Patent Application Publication
(10) Pub. No.: US 2019/0230296 A1
(43) Pub. Date: Jul. 25, 2019

(54) PICTURE PROCESSING DEVICE, METHOD OF PRODUCING PICTURE DATA, AND PICTURE PROCESSING PROGRAM

(71) Applicant: SEIKO EPSON CORPORATION, Tokyo (JP)

(72) Inventor: Masatoshi MATSUHIRA, Matsumoto (JP)

(21) Appl. No.: 16/254,704

(22) Filed: Jan. 23, 2019

(30) Foreign Application Priority Data
Jan. 25, 2018 (JP) 2018-010298

(51) Int. Cl. H04N 5/262; G06F 3/0488; G06K 9/00; G06F 3/0484

(52) U.S. Cl. CPC H04N 5/2628; G06F 3/04883; G06F 2203/04808; G06F 3/04845; G06K 9/00221

(57) ABSTRACT

Provided is a picture processing device including: an acquisition unit that acquires a picture; a recognition unit that recognizes a face portion from the picture; a touchscreen that displays the picture; and a picture processing unit that, when a pinch operation on the picture displayed on the touchscreen, performs a moving process of moving the face portion to the center of a frame in response to the pinch operation and a scaling process of changing picture size while maintaining the face portion at the center of the frame in response to the pinch operation on the moved picture.

### CROSS REFERENCE TO RELATED APPLICATIONS

The present invention contains subject matter related to Japanese Patent Application No. 2018-010298 filed in the Japanese Patent Office on Jan. 25, 2018, the entire contents of which are incorporated herein by reference.

### BACKGROUND

### 1. Technical Field

The invention relates to a picture processing device, a method of producing picture data, and a picture processing program.

### 2. Related Art

A conventional technology of scaling up a face portion in a picture is known (see, for example, JP-A-2003-108979)

In the related art, a complex operation is needed to generate an image of a desired size in which a face portion is located at the center.

### SUMMARY

According to an aspect of the invention, a picture processing device includes: an acquisition unit that acquires a picture; a recognition unit that recognizes a face portion from the picture; a touchscreen that displays the picture; and a picture processing unit that, when a pinch operation is performed on the picture displayed on the touchscreen, performs a moving process of moving the face portion to the center of a frame in response to the pinch operation and a scaling process of changing picture size while maintaining the face portion at the center of the frame in response to the pinch operation on the moved picture. According to such a configuration, an image of a desired size in which a face portion is located at the center can be easily generated.

Furthermore, in the moving process, the picture processing unit may move the face portion to the center of the frame in response to the pinch operation while maintaining the picture size. According to such a configuration, it is possible to move the face portion to the center and then change the size thereof.

Furthermore, in the moving process, the picture processing unit may the picture processing unit moves the face portion to a target region whose center matches the center of the frame while changing the face portion size. According to such a configuration, a moving process and a scaling process can be performed at the same time.

Furthermore, the target region may be inscribed in the frame. According to such a configuration, a picture can be scaled by using the frame as a reference.

Furthermore, the target region may be circumscribed on a rectangle including the face portion. According to such a configuration, a picture can be scaled by using a rectangle including a face portion as a reference.

Furthermore, a difference between a region of the face portion obtained before a change of the picture size and a region obtained in accordance with a distance of the pinch operation may be divided into a predetermined number of movement intervals, and the picture size may be changed in a stepwise basis. According to such a configuration, a change of the size can be performed in response to a pinch operation.

Furthermore, the picture processing unit may perform a cutout process of cutting out an image in the frame on which a process caused by the pinch operation has been performed. According to such a configuration, picture data in which the size has been changed can be generated.

### BRIEF DESCRIPTION OF THE DRAWINGS

The invention will be described with reference to the accompanying drawings, wherein like numbers reference like elements.

FIG. 1 is a block diagram illustrating a configuration of a picture processing device.

FIG. 2 is a flowchart illustrating an operation detection process.

FIG. 3 is a flowchart illustrating a picture process.

FIG. 4 is a diagram illustrating a pinch-out operation.

FIG. 5 is a diagram illustrating a target rectangle.

FIG. 6 is a diagram illustrating a moving process.

FIG. 7 is a diagram illustrating a scale-up process.

FIG. 8 is a diagram illustrating motion in response to a pinch-out operation.

FIG. 9 is a diagram illustrating scale-up in response to a pinch-out operation.

FIG. 10 is a diagram illustrating a target rectangle in a second embodiment.

FIG. 11 is a diagram illustrating a moving process and a scale-up process in the second embodiment.

FIG. 12 is a diagram illustrating a moving process and a scale-up process in the second embodiment.

FIG. 13 is a diagram illustrating a moving process and a scale-up process in the second embodiment.

### DESCRIPTION OF EXEMPLARY EMBODIMENTS

Embodiments of the invention will be described in the following order.

(1) Configuration of Picture Processing Device

(2) Operation Detection Process

(3) Picture Process

(4) Second Embodiment

(5) Other Embodiments

### (1) Configuration of Picture Processing Device

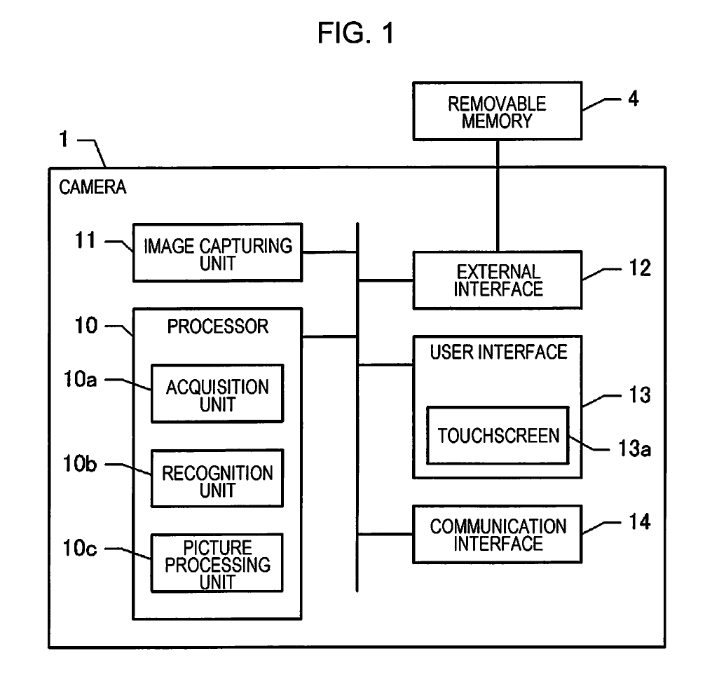

FIG. 1 is a block diagram illustrating a configuration of a camera 1 including a picture processing device according to the embodiment of the invention. The camera 1 includes a processor 10, an image capturing unit 11, an external interface 12, a user interface 13, and a communication interface 14. The processor 10 has a CPU, a RAM, a ROM, a non-volatile memory, and the like. The CPU executes various programs stored in the ROM or the non-volatile memory by using the RAM or the like, and thereby the processor 10 controls respective components of the camera 1. An ASIC may be used instead of the CPU, or the CPU and an ASIC may be used cooperatively. Various programs may include an image capture processing program used to capture pictures, a picture processing program used to display pictures or the like, and the like. Note that the processor 10 functions as a processing unit, a recognition unit, or a picture processing unit.

The image capturing unit 11 includes an optical system (not illustrated), an area image sensor (not illustrated), an ASIC (not illustrated), a VRAM (not illustrated), or the like. The ASIC controls the optical system or the area image sensor in accordance with control by the processor 10 and generates picture data representing a subject image. The external interface 12 reads and writes various data including picture data from and to a removable memory 4 connected to the camera 1 in accordance with control by the processor 10.

The user interface 13 has a touchscreen 13a and keys (not illustrated), which detect a user operation performed on the touchscreen 13a or the keys to notify the processor 10 of the detected user operation and displays various images or text on the touchscreen 13a in accordance with control by the processor 10. The communication interface 14 converts transmission data or transmits a signal via a transmission path in accordance with a communication protocol to transmit data to an external device in accordance with an instruction from the processor 10. Further, the communication interface 14 receives a signal transmitted from an external device, acquires received data in accordance with a communication protocol, and notifies the processor 10 of the acquired received data.

In the present embodiment, the processor 10 can execute an image capture processing program to take a picture. That is, the processor 10 can accept a user operation performed on the user interface 13 and acquire, as picture data, an image captured on the area image sensor by the image capturing unit 11. The picture data representing a captured image is stored in the removable memory 4.

Further, the processor 10 can execute the picture processing program and display a captured picture or a picture stored in the removable memory 4 on the touchscreen 13a. A user is able to review a picture by operating the touchscreen 13a to scale or move the picture while the picture is displayed on the touchscreen 13a.

That is, in the present embodiment, the user is able to scale up a picture by performing a pinch-out operation on the touchscreen 13a and review the degree of focusing, the degree of blur, or the like, for example. In particular, in a case of a picture of a person, it is desirable to review whether or not the face of the person is in focus, whether or not the person has open eyes, or the like. In the present embodiment, in such a case, it is possible to move a face portion included in a picture to the center of the touchscreen 13a and scale up the face portion in the picture.

To implement such a process, when the picture processing program is executed, the processor 10 functions as an acquisition unit 10a, a recognition unit 10b, and a picture processing unit 10c. The acquisition unit 10a is a program module that causes the processor 10 to perform a function of acquiring a picture. That is, the processor 10 accepts a user operation performed on the user interface 13 and accepts designation of picture data stored in the removable memory 4.

Once picture data is designated, the processor 10 references the removable memory 4 and acquires the designated picture data. The acquired picture data is stored in the RAM. Further, in the present embodiment, the processor 10 displays the acquired picture data on the touchscreen 13a. That is, the processor 10 outputs a control signal to the touchscreen 13a to display the picture data stored in the RAM on the touchscreen 13a. In the present embodiment, a picture is displayed on the touchscreen 13a at the maximum size as a default setting as long as the entire picture is displayed. Note that in the present embodiment, when the pixel dimensions of picture data do not match the number of pixels in a display region of the touchscreen 13a, a reduction process or another size adjustment process may be performed, regardless of scale-up or scale-down of picture data being performed.

The recognition unit 10b is a program module that causes the processor 10 to implement a function of recognizing a face in a picture. Various recognition algorithms may be employed. In the present embodiment, the processor 10 recognizes a face of a person by extracting, from a picture, a portion which matches a predetermined pattern. For example, the predetermined pattern is defined by determining whether or not the edge shape in a region surrounded by an edge or a part located within the region (eyes, nose, mouth, eyebrows, or the like) matches a pattern of a face of a person. The definition of a pattern is not limited to the above, and various schemes may be employed. In the present embodiment, the processor 10 recognizes a face of a person by identifying a rectangle circumscribed on the face of a person (hereinafter, referred to as a face rectangle). Note that when multiple faces are included in a single picture, multiple faces are recognized.

When a pinch operation is performed on a picture displayed on the touchscreen 13a, the picture processing unit 10c causes the processor 10 to perform a function of a moving process to move the face portion to the center of a frame in response to the pinch operation and a function of a scaling process to change the size of the moved picture in response to the pinch operation while maintaining the position of the face portion at the center of the frame.

Although the scaling process in the present embodiment includes a scale-up process to increase the size of a picture and a scale-down process to reduce the size of a picture, either of the scale-up process and the scale-down process may be used. Further, although these processes may be performed in response to a pinch operation, in the present embodiment, a scale-up process is performed in response to a pinch-out operation, and a scale-down process is performed in response to a pinch-in operation. Thus, in the present embodiment, image processing and pinch operations are associated with each other in an intuitive manner. For simplicity, a pinch-out operation will be mainly described below.

In the present embodiment, the frame is the center of a display area of the touchscreen 13a. That is, in the present embodiment, when a picture is displayed on the touchscreen 13a, a picture is displayed in the entire display area of the touchscreen 13a, and the display area is the frame used for displaying a picture. A face portion included in a picture may be located at any position. When a face portion is scaled up for reviewing its picture quality, scaling up from a state where the face portion is located at the end of the picture may cause the portion intended by the user to extend beyond the frame.

In such a case, when shift of a picture is possible, a portion intended by the user can be displayed on the touchscreen 13a, but an operation for such a shift is complex. Further, when the intended portion is beyond the frame, it is often difficult to move the intended portion into the frame.

Accordingly, in the present embodiment, the processor 10 centers a picture in the frame in response to a pinch-out operation when scaling up the picture through a pinch-out operation. As a result, an image of any size in which a face portion is centered can be easily generated. Further, since centering a picture in addition to adjustment of the size of a picture can be performed by a pinch operation alone, it is possible to easily review the state in which a face portion intended by the user was captured.

### (2) Operation Detection Process

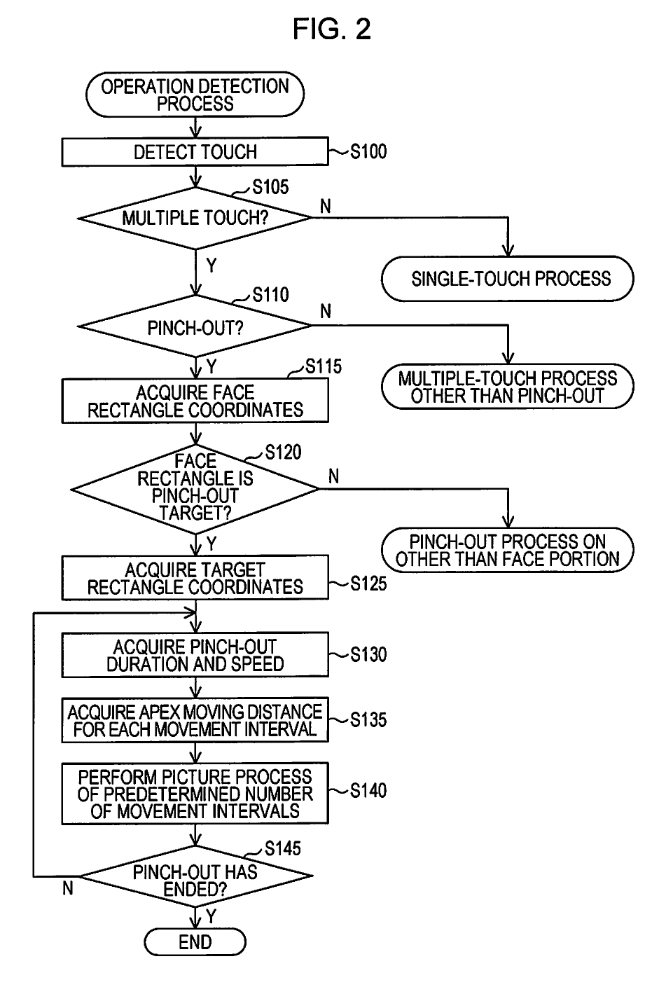

Next, the process performed by the processor 10 of the camera 1 illustrated in FIG. 1 will be described in detail. FIG. 2 is a flowchart illustrating the operation detection process performed by the processor 10 for detecting a pinch operation. Note that, although a pinch-out operation is now mainly described, the same process is applicable to pinch-in operations.

Once the user provides an instruction to display a picture, the processor 10 accepts a user operation performed via the user interface 13 and accepts designation of picture data stored in the removable memory 4 by using the function of the acquisition unit 10a. Further, the processor 10 references the removable memory 4 and acquires the designated picture data to display the acquired designated picture data on the touchscreen 13a.

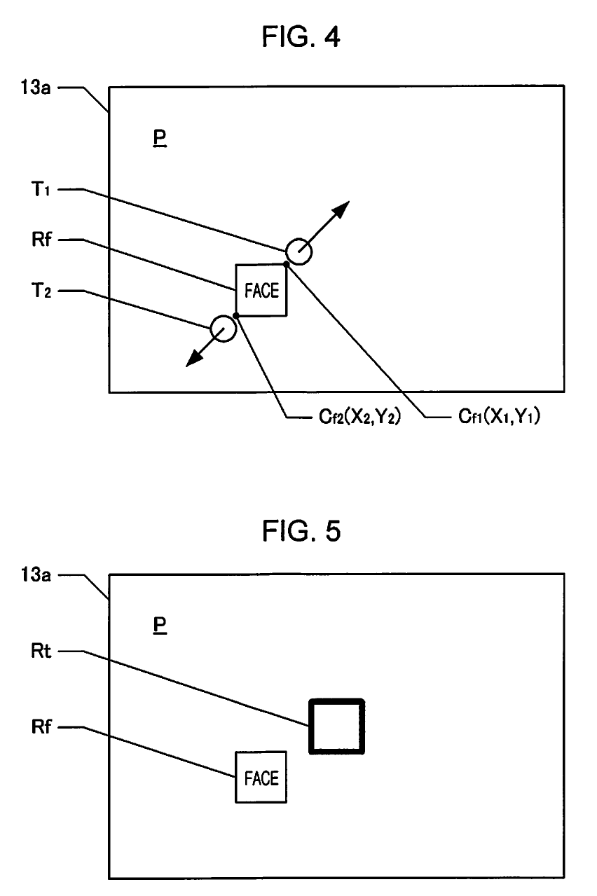

FIG. 4 is a diagram schematically illustrating a picture displayed on the touchscreen 13a. In the example illustrated in FIG. 4, it is assumed that a picture P is displayed over the entire area of the touchscreen 13a, and it is assumed that a face of a person is included in the picture P. In FIG. 4, the face of a person is represented by the word “FACE”. An example of the process will be described below with reference to the example.

In a state where a picture is displayed on the touchscreen 13a, in response to the user touching the touchscreen 13a, the operation detection process is started. Upon the start of the operation detection process, the processor 10 starts detecting a touch position in accordance with an output signal from the user interface 13 by using the function of the picture processing unit 10c. That is, coordinates are allocated in advance to the touchable region of the touchscreen 13a, and in response to a touch operation on the touchscreen 13a, the user interface 13 outputs information indicating touch coordinates of the touch.

In response to acquiring the touch coordinates, the processor 10 recognizes that the user is touching the touchscreen 13a and acquires the touch position as touch coordinates. Note that a plurality of touch positions may be acquired in the present embodiment. That is, when the user touches the touchscreen 13a with multiple fingers, the positions touched by respective fingers are acquired as touch coordinates. Once touch detection in step S100 is performed, a touch detection process continues while a touch operation at one or more positions continues. The processor 10 acquires touch coordinates indicating the touched position at short predetermined time intervals. Therefore, when a touch position changes, the processor 10 can recognize the change in the touch position.

Next, the processor 10 determines by using the function of the picture processing unit 10c whether or not multiple touch operations are performed (step S105). That is, the processor 10 determines that there are multiple touch operations upon detection of a plurality of touch positions in step S100. If it is not determined that multiple touch operations are performed in step S105, the processor 10 executes a single-touch process. That is, a touch operation that does not consist of multiple touch operations is a single touch operation, and accordingly the processor 10 performs a process for a single touch operation.

Note that the single-touch process may correspond to various processes. For example, the process may be configured such that, when a touch position changes with the touchscreen 13a being touched, the processor 10 identifies the operation as a slide operation or a swipe operation and moves a touched object or the like (such as moving of a picture, for example). Further, the process may be configured such that, when the touchscreen 13a is touched and the touch is then released, the processor 10 identifies the operation as a tap operation and performs an instruction related to a touched object or the like (an instruction to save a picture, for example).

Next, the processor 10 determines by using the picture processing unit 10c whether or not a pinch-out operation is being performed (step S110). That is, when two touch positions are detected in step S100 and the distance thereof is increasing, the processor 10 determines that a pinch-out operation is being performed. If a pinch-out operation is not determined in step S110, the processor 10 performs a multiple-touch process which is different to that for a pinch-out operation.

Note that the multiple-touch process which is different to that for a pinch-out operation may correspond to various processes. For example, the process may be configured such that, when touched positions are shifted in parallel while the touchscreen 13a is being touched, the processor 10 identifies the operation as a slide operation or a swipe operation caused by multiple-touch operations and moves a touched object or the like (such as moving of a picture, for example).

The example illustrated in FIG. 4 schematically illustrates a pinch-out operation being performed on the picture P displayed on the touchscreen 13a. That is, in FIG. 4, initial touch positions T₁ and T₂ are each represented by a circle, changes of the touch positions are represented by arrows extending from the touch positions. In FIG. 4, a change of the touch positions to be further away from each other indicates that a pinch-out operation has been performed.

If it is determined in step S110 that a pinch-out operation is being performed, the processor 10 acquires face rectangle coordinates by using the function of the recognition unit 10b (step S115). That is, the processor 10 performs a face recognition process in accordance with picture data indicating a picture displayed on the touchscreen 13a and recognizes a face of a person located within the picture. Upon recognition of the face of a person, the processor 10 identifies a rectangle circumscribing the outline of the face of a person and acquires a face rectangle. The processor 10 then acquires face rectangle coordinates used to identify the face rectangle. Note that face rectangle coordinates may be any coordinates that can identify the position of a face rectangle. In the present embodiment, in the coordinate system representing positions of pixels forming a picture, the coordinates indicating two diagonally disposed apexes of the face rectangle are face rectangle coordinates. While a face rectangle Rf is represented by a solid line in FIG. 4, a face rectangle may or may not be displayed on the actual touchscreen 13a. Further, FIG. 4 illustrates face rectangle coordinates C_{f1}(X₁, Y₁) and C_{f2}(X₂, Y₂).

Next, the processor 10 determines by using the function of the picture processing unit 10c whether or not the face rectangle is a target of the pinch-out operation (step S120). That is, the processor 10 determines whether or not the pinch-out operation is an operation of scaling up a face portion in accordance with a predetermined determination criterion. The determination criterion may be a criterion determined in advance, for example, a criterion for determining that a face rectangle is a pinch-out target when the face rectangle is located on a line connecting the initial touch positions.

FIG. 4 illustrates an example in which it is determined by the determination criterion that the face rectangle Rf is a pinch-out target. That is, since the face rectangle Rf is located on a line connecting the initial tough positions T₁ and T₂ of a pinch-out operation, the face rectangle Rf is a pinch-out target.

If it is not determined that a face rectangle is a pinch-out target in step S120, the processor 10 performs a pinch-out process on a portion other than a face portion. The pinch-out process on a portion other than a face portion may correspond to various processes, for example, a process of scaling up an image without moving a face rectangle to the center of the frame.

If it is determined in step S120 that a face rectangle is a pinch-out target, the processor 10 acquires target rectangle coordinates by using the function of the picture processing unit 10c (step S125). In this example, since the target rectangle coordinates define a rectangular target region that is a target for a moving process and a scaling process, such a region is referred to as a target rectangle. In the present embodiment, a target rectangle is congruent with a face rectangle and is centered in the frame (a picture display region of the touchscreen 13a). Note that the target rectangle coordinates may be any coordinates that can identify the position of a face rectangle. In the present embodiment, in a coordinate system representing positions of pixels forming a picture, coordinates indicating two diagonally disposed apexes of a face rectangle are target rectangle coordinates.

Note that a target rectangle is a target of a moving process and a scaling process, and the processor 10 changes a face rectangle such that the face rectangle overlaps the target rectangle in response to a pinch-out operation. Further, when a pinch-out operation continues after a target rectangle and a face rectangle overlap each other, a picture is scaled up so that the face rectangle becomes larger than the target rectangle. Therefore, when the target rectangle and the face rectangle are congruent as illustrated in the present embodiment and when a face rectangle is changed so as to overlap a target rectangle, a process of moving a face portion to the center of the frame is performed in response to a pinch operation while the size of a picture is maintained (as described later in detail). FIG. 5 illustrates the same example as that illustrated in FIG. 4, and the target rectangle Rt is illustrated by a bold solid line. Note that the target rectangle is not actually displayed on the touchscreen 13a.

Next, the processor 10 acquires a duration and a speed of a pinch-out operation by using the function of the picture processing unit 10c (step S130). The present embodiment is configured to perform a moving process and a scaling process within a time period equal to the duration of the user performing a pinch-out operation. Accordingly, after it is determined in step S110 that a pinch-out operation is being performed, the processor 10 performs a process that starts measuring the time and stops measuring the time when the pinch-out operation ends (the touch operation on at least one of the two touch positions ends).

The duration of a pinch-out operation is measured at predetermined time intervals (for example, at time intervals described later). During a pinch-out operation, the duration of the pinch-out operation is periodically updated and stored in the RAM or the like. Upon completion of the pinch-out operation, information indicating the completion of the pinch-out operation is stored in the RAM or the like in association with the pinch-out duration.

The pinch-out speed is determined in accordance with the change in the touch position per unit time. That is, the processor 10 determines the length along which the distance between two touch positions changes per unit time in accordance with a result of detecting touch positions in step S100. The unit time may be any duration provided that it is longer than the duration of a time interval described later. In this example, the unit time is assumed to be the same as the sum of a predetermined number (N) of time intervals. Note that the time interval may be 1/30 seconds or the like, for example.

Next, the processor 10 acquires the apex moving distance per movement interval by using the function of the picture processing unit 10c (step S135). That is, in the present embodiment, the processor 10 performs moving and scaling in a fine-stepwise manner to move the face portion and displays a moving image being scaled. The minimum unit of such moving or scaling is a movement interval, and the time required for one movement interval is the time interval. The degree of moving or scaling in a stepwise manner is determined by the pinch-out speed per unit time. In the present embodiment, the apex moving distance per unit time is associated with the pinch-out speed, and the processor 10 acquires the apex moving distance in a stepwise manner by dividing the apex moving distance per unit time by the predetermined number N. The apex moving distance in a stepwise manner is stored in the RAM or the like.

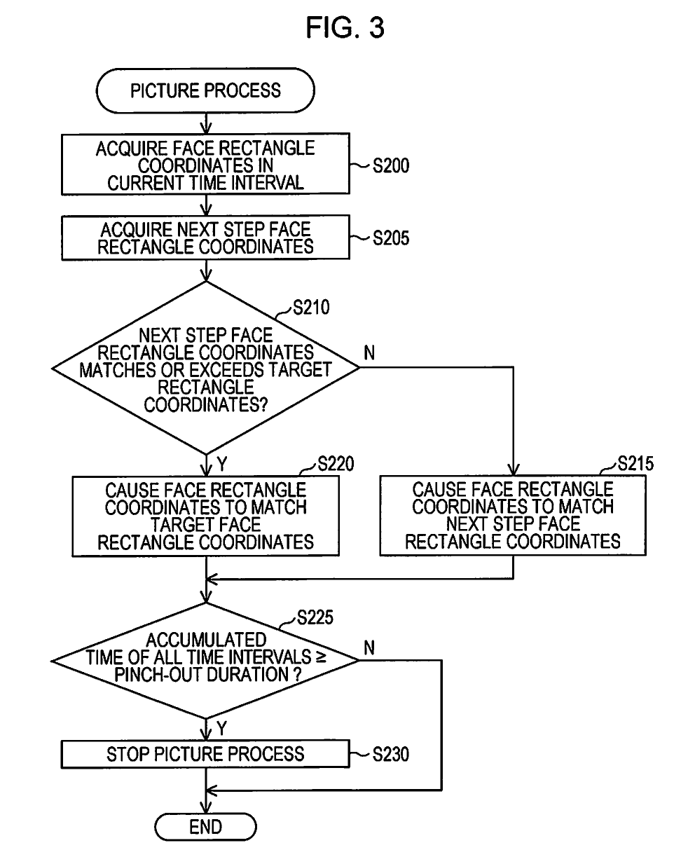

Next, the processor 10 performs a picture process for a predetermined number of movement intervals by using the function of the picture processing unit 10c (step S140). The picture process will be described later (FIG. 3). The processor 10 then determines by using the function of the picture processing unit 10c whether or not the pinch-out operation has ended (step S145). That is, the processor 10 determines that the pinch-out operation is completed when the touch operation on at least one of the two touch position ends. If it is not determined in step S145 that the pinch-out operation has ended, the processor 10 repeats the process on and after step S130. If it is determined in step S145 that the pinch-out operation has ended, the processor 10 ends the operation detection process.

### (3) Picture Process

Next, the picture process in step S140 will be described. The picture process is an interrupt process executed for moving or scaling over a predetermined number of movement intervals, and in response to the execution of step S140, the picture process is repeated a predetermined number of times during a continuous pinch-out operation. Once the picture process is started, the processor 10 acquires face rectangle coordinates in the current time interval (step S200). That is, the face rectangle coordinates change due to a moving process or a scaling process, and the changed face rectangle coordinates are stored in the RAM. Accordingly, the processor 10 references the RAM and acquires face rectangle coordinates. FIG. 4 illustrates the face rectangle Rf in the initial display state on which neither the moving process nor the scaling process has been performed. When a picture process is started in response to a pinch-out operation in this state, face rectangle coordinates C_{f1}(X₁, Y₁) and C_{f2}(X₂, Y₂) are acquired in step S200.

Next, the processor 10 acquires next step face rectangle coordinates (step S205). In the present embodiment, the processor 10 acquires next step face rectangle coordinates by using different schemes before and after a face rectangle is moved to the center of the frame. Specifically, before a face rectangle is moved to the center of the frame, the processor 10 moves a face portion to the center of the frame in response to a pinch-operation while maintaining the size of the picture.

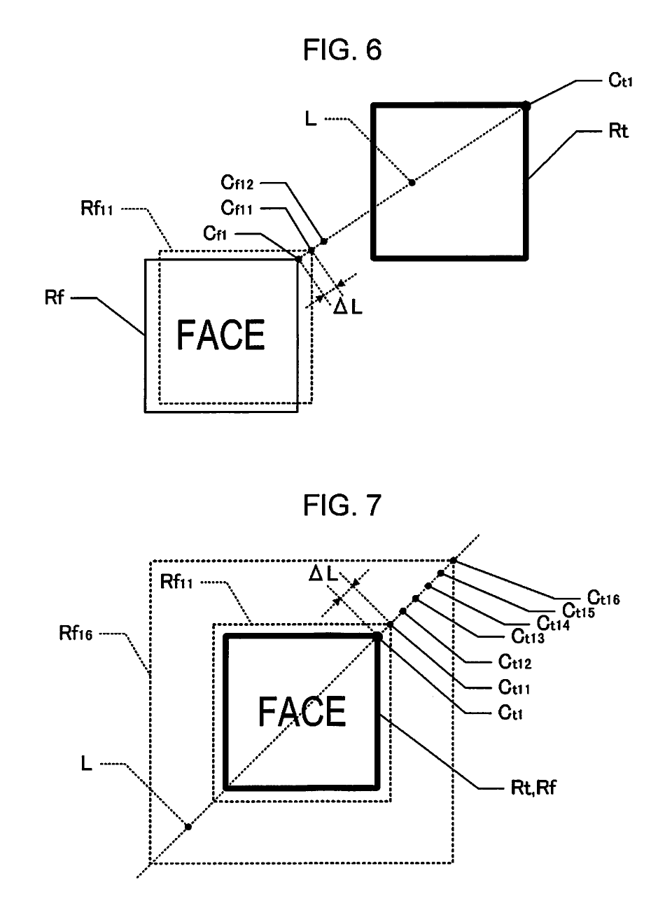

To perform such a process, the processor 10 acquires a line connecting the initial face rectangle coordinates to the target rectangle coordinates. FIG. 6 illustrates the initial face rectangle Rf illustrated in FIG. 4 and the target rectangle Rt, which illustrates the dotted line L connecting the face rectangle coordinates C_{f1} in the initial face rectangle Rf to the target rectangle coordinates Cₜ₁ in the target rectangle Rt.

The processor 10 acquires next step face rectangle coordinates on the line L connecting the initial face rectangle coordinates to the target rectangle coordinates. That is, in step S135, because the apex moving distance in each movement interval is already acquired, the processor 10 acquires, as the next step face rectangle coordinates, a position shifted on the line L from the face rectangle coordinates in the current time interval to the apex of the target rectangle by the apex moving distance in each movement interval. In FIG. 6, the apex moving distance in each movement interval is denoted as distance ΔL, and the next step face rectangle coordinates shifted from the face rectangle coordinates C_{f1} in the current time interval are denoted as coordinates C_{f11}. Further, the next step face rectangle coordinates shifted from the face rectangle coordinates C_{f11} in the current time interval are denoted as coordinates C_{f12}.

On the other hand, after the face rectangle is moved to the center of the frame, the processor 10 performs a scale-up process to scale up the face rectangle so that the apex moving distance becomes equal to the apex moving distance in each movement interval acquired in step S135. To perform such a process, the processor 10 acquires a diagonal line of the target rectangle. FIG. 7 illustrates a state where the face rectangle Rf illustrated in FIG. 4 has been moved and matches the target rectangle Rt, and one of the diagonal lines is indicated by the dotted line as a diagonal line L.

The processor 10 acquires the next step face rectangle coordinates on the diagonal line L. That is, in step S135, because the apex moving distance in each movement interval is already acquired, the processor 10 acquires, as the next step face rectangle coordinates, a position shifted on the diagonal line L from the face rectangle coordinates in the current time interval by the apex moving distance from the apex of the target rectangle in each movement interval. In FIG. 7, the apex moving distance in each movement interval is denoted as distance ΔL, and the next step face rectangle coordinates shifted from the face rectangle coordinates Cₜ₁ in the current time interval are denoted as coordinates Cₜ₁₁. Further, the next step face rectangle coordinates shifted from the face rectangle coordinates Cₜ₁₁ in the current time interval are denoted as coordinates Cₜ₁₂.

Once the next step face rectangle coordinates are acquired, the processor 10 determines whether or not the next step face rectangle coordinates match the target rectangle coordinates (step S210). That is, after repeating the process of acquiring next step face rectangle coordinates, the face rectangle coordinates approach the target rectangle coordinates. If the distance between the initial face rectangle coordinates and the target rectangle coordinates on the line L or the diagonal line L described above is an integer multiple of the apex moving distance of each movement interval, the next step face rectangle coordinates may match the target rectangle coordinates.

On the other hand, unless the distance between the initial face rectangle coordinates and the target rectangle coordinates on the line L or the diagonal line L described above is an integer multiple of the apex moving distance of each movement interval, the next step face rectangle coordinates do not match the target rectangle coordinates. Further, when the face rectangle coordinates are closest to the target rectangle coordinates, the next step face rectangle coordinates exceed the target rectangle coordinates.

In any case, if next step face rectangle coordinates acquired in step S205 match or exceed the target rectangle coordinates, the process is in the final step of the moving process, and further moving after the movement interval will move the face rectangle away from the target rectangle. Accordingly, in step S210, the processor 10 determines whether or not the face rectangle coordinates match or exceed the target rectangle coordinates and thereby determines whether or not the process is in the final step of the moving process.

Next, in step S210, if the next step face rectangle coordinates do not exceed the target rectangle coordinates, the processor 10 adjusts the face rectangle coordinates to match next step face rectangle coordinates (step S215). That is, the processor 10 performs the moving process or the scaling process.

Specifically, if the face rectangle has not been moved to the center of the frame, the processor 10 shifts the face rectangle so that the next step face rectangle coordinates acquired in step S205 are updated to new face rectangle coordinates. That is, the processor 10 changes the display position of an image of a picture by defining a vector from the face rectangle coordinates in the current time interval to the next step face rectangle coordinates as a motion vector and displays the image on the touchscreen 13a. For example, when the face rectangle coordinates in the current time interval are coordinates C_{f1} illustrated in FIG. 6 and when the next step face rectangle coordinates are coordinates C_{f11}, the processor 10 moves a picture so that the face rectangle Rf moves to the face rectangle Rf₁₁.

When the face rectangle has been moved to the center of the frame, the processor 10 scales up the face rectangle so that next step face rectangle coordinates acquired in step S205 are updated with new face rectangle coordinates. That is, the processor 10 calculates a scale-up rate when changing face rectangle coordinates from the face rectangle coordinates in the current time interval to the next step face rectangle coordinates and scales up the picture by using an interpolation process or the like. The processor 10 then sets a display position of the picture so as to not move the center of the original face rectangle Rf and displays the scaled-up picture on the touchscreen 13a. For example, when the face rectangle coordinates in the current time interval are coordinates Cₜ₁ illustrated in FIG. 7 and when the next step face rectangle coordinates are coordinates Cₜ₁₁, the processor 10 performs a scale-up operation and a display operation so that the face rectangle Rf is scaled up to the face rectangle Rf₁₁.

Note that, in the present embodiment, the unit time for acquiring the pinch-out speed is divided into a predetermined number of intervals, and the size of a picture is changed in a stepwise manner in successive intervals. FIG. 7 illustrates a case of the predetermined number N being 6, for example. That is, in this example, the apex moving distance identified from the pinch-out speed within the unit time is the distance between coordinates Cₜ₁ and Cₜ₁₆, and the apex moving distance in each interval that is obtained by dividing the distance by the predetermined number, namely, 6, is the distance between coordinates Cₜ₁ₙ and Cₜ₁ₙ₊₁ (n is an integer from 1 to 5). Then, a scale-up operation is performed so that each apex is moved by the apex moving distance in each interval. Therefore, in the present embodiment, the processor 10 performs a process of dividing a region (Rf₁₆ illustrated in FIG. 7) based on the length of a pinch operation and a face region (Rf illustrated in FIG. 7) obtained before the change of size into a plurality of movement intervals and changing the size of the picture in a stepwise manner. According to such a configuration, it is possible to change the size smoothly in response to a pinch operation.

On the other hand, if it is determined in step S210 that the next step face rectangle coordinates exceed the target rectangle coordinates, the processor 10 adjusts the face rectangle coordinates to match the target rectangle coordinates (step S220). That is, in the present embodiment, the processor 10 performs step S220 in the final step of the moving process and thereby performs a moving process so that the face rectangle does not move beyond the target rectangle and out of the center of the frame. If the process is not in the final step of the moving process, the processor 10 performs a moving process or a scaling process in step S215.

If step S220 is performed, the processor 10 moves the face rectangle so that the face rectangle coordinates in the current time interval match the target rectangle coordinates. That is, the processor 10 changes the display position of an image of a picture by defining, as a motion vector on the line L, the vector reaching the target rectangle coordinates from the face rectangle coordinates in the current time interval and displays the image on the touchscreen 13a. As a result, the picture is moved so that the center of the face rectangle matches the center of the frame. Therefore, in the present embodiment, a process of moving a face portion to the center of the frame in response to a pinch operation is performed while the size of a picture is maintained.

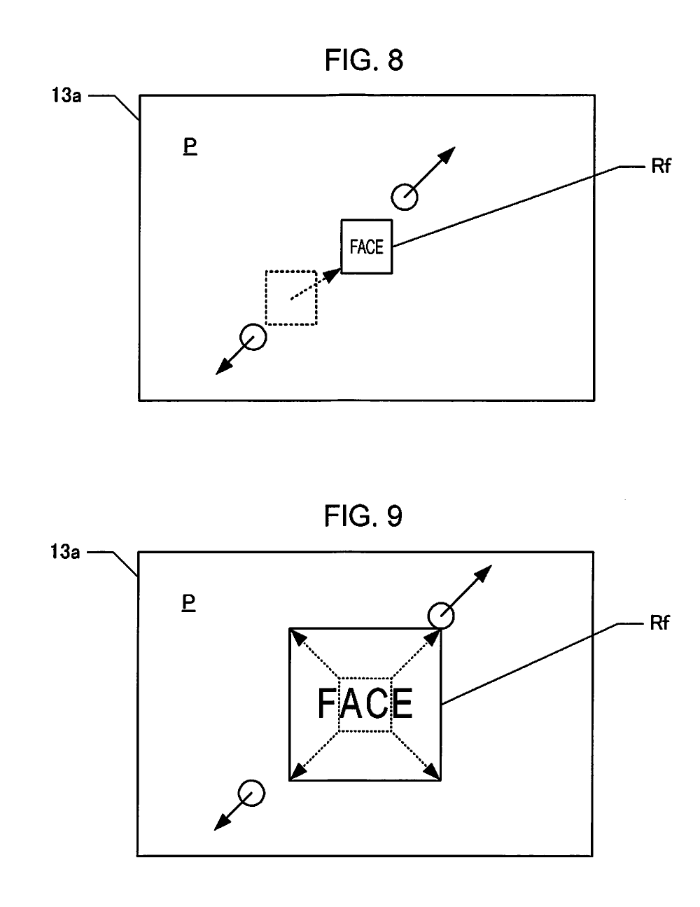

According to the configuration described above, it is possible to change the size of a face portion after moving the face portion to the center. That is, in the example illustrated in FIG. 4, when a pinch-out operation continues, the face rectangle Rf is moved to the center of the frame of the touchscreen 13a as illustrated in FIG. 8. When a pinch-out operation continues even after the face rectangle Rf reached the center of the frame of the touchscreen 13a as illustrated in FIG. 8, the face rectangle Rf is scaled up and displayed while the position of the face rectangle Rf on the touchscreen 13a is maintained, as illustrated in FIG. 9.

Once step S215 or step S220 is performed, the processor 10 determines whether or not accumulated time of all the time intervals is above a pinch-out duration (step S225). That is, in the present embodiment, a moving process or a scaling process is performed during a period when a pinch-out operation continues. Accordingly, the processor 10 acquires accumulated time for all the time intervals in accordance with a product of each time interval and the number of movement intervals completed for the related process from the start of a picture process to the current time. Then, if the accumulated time of all the time intervals is above a pinch-out duration, it is determined that the process has to end.

Thus, if it is determined that the accumulated time of all the time intervals is above the pinch-out duration in step S225, the processor 10 terminates the picture process caused by the pinch-out operation (step S230). In such a case, even if the picture process illustrated in FIG. 3 has not been repeated for a predetermined number of times after started in step S140, no further picture process is repeated, and the process caused by the pinch-out operation ends.

However, if it is not determined that the accumulated time of all the time intervals is above the pinch-out duration in step S225, the processor 10 ends the picture process. In such a case, if the picture process illustrated in FIG. 3 has not been repeated for a predetermined number of times after started in step S140, the picture process is re-started until a predetermined number of repetitions are performed.

### (4) Second Embodiment

While, in the first embodiment described above, a scaling process is performed after a moving process is performed, the moving process and the scaling process may be performed in parallel. That is, a process of changing the size of a face portion to a target region having the same center as the frame may be performed in a moving process. Such a configuration is realized by setting the size of a target rectangle to be larger than the size of a face rectangle and defining the target rectangle as a target region in the first embodiment described above, for example.

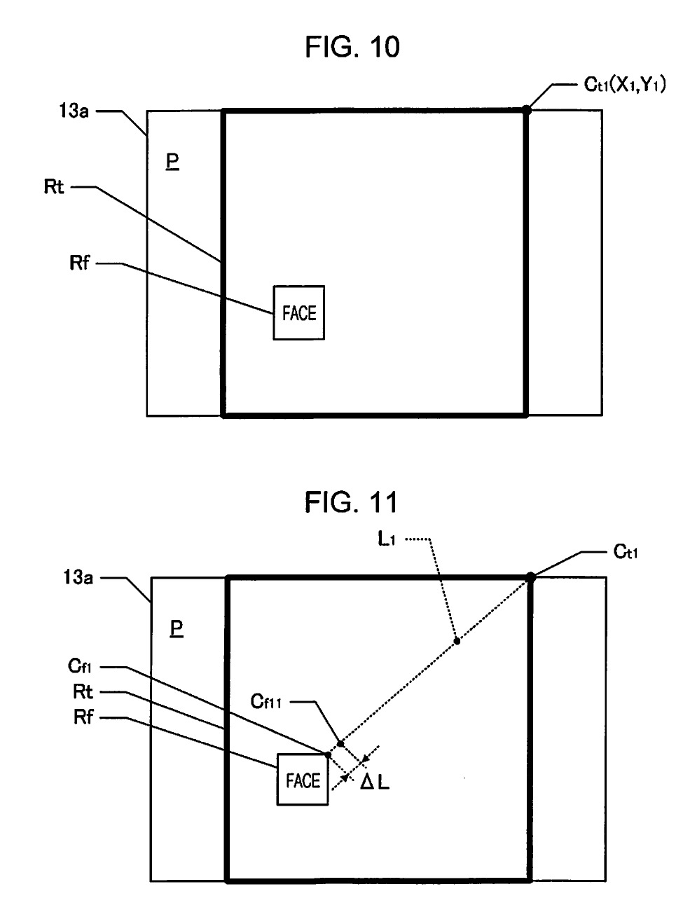

FIG. 10 illustrates a picture P as an example that is the same as the picture P illustrated in FIG. 4, and it is assumed in this example that a target rectangle Rt inscribed in the frame is formed. In this example, such a configuration is assumed that uses the target rectangle Rt and performs the process illustrated in FIG. 2 and FIG. 3 in the configuration illustrated in FIG. 1. A main part of the process will be described below with reference to FIG. 10 to FIG. 12.

In step S125 in FIG. 2, the processor 10 defines, as the target rectangle Rt, a rectangle which is a similar figure to the face rectangle Rf, has the same center as the frame of the touchscreen 13a, and is inscribed in the frame. In step S125, the processor 10 then acquires at least a part of target rectangle coordinates. In this example, a case where target rectangle coordinates Cₜ₁(X₁, Y₁) illustrated in FIG. 10 will be described as an example. In the process illustrated in FIG. 2, other steps than step S125 are the same as those in the first embodiment described above.

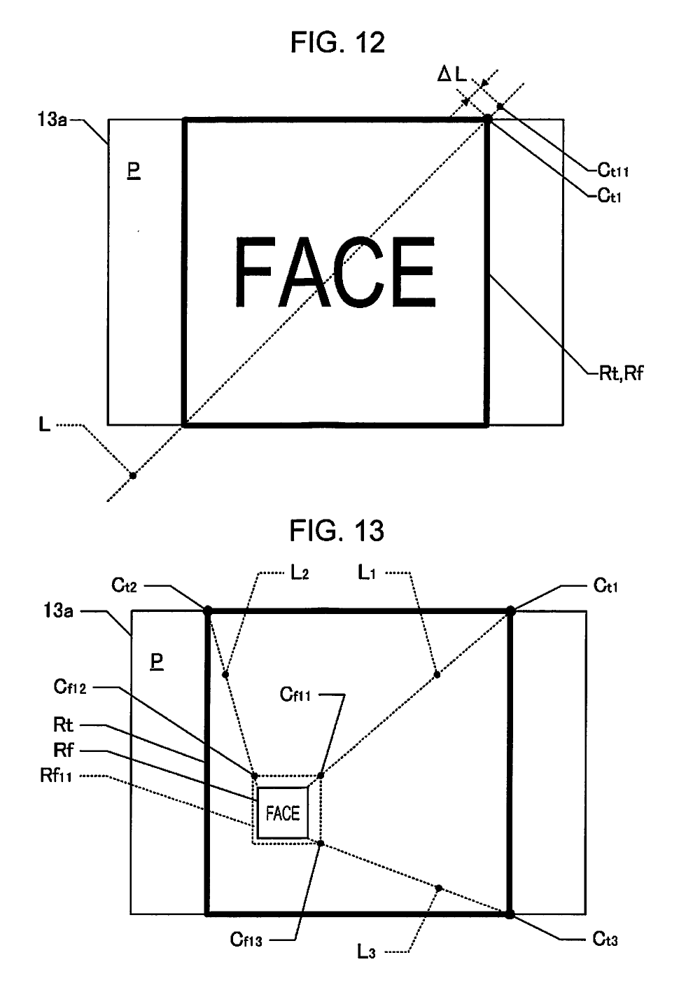

FIG. 11 and FIG. 12 are diagrams illustrating step S205 in the second embodiment. In response to the process of acquiring next step face rectangle coordinates before the face rectangle is moved to the center of the frame, the processor 10 acquires a line L₁ connecting face rectangle coordinates C_{f1} in the initial face rectangle Rf to target rectangle coordinates Cₜ₁ in the target rectangle Rt, as illustrated in FIG. 11.

Further, the processor 10 acquires next step face rectangle coordinates on the line L₁. That is, in step S135, since the apex moving distance for each movement interval is already acquired, the processor 10 acquires, as next step face rectangle coordinates, the position shifted on the line L₁ from the face rectangle coordinates in the current time interval to the apex of the target rectangle by the apex moving distance for each movement interval. In FIG. 11, the apex moving distance for each movement interval is denoted as distance ΔL, and the next step face rectangle coordinates shifted from the face rectangle coordinates C_{f1} in the current time interval are denoted as coordinates C_{f11}.

After the face rectangle is moved to the center of the frame, in response to the process of acquiring next step face rectangle coordinates, the processor 10 acquires the diagonal line L of the target rectangle illustrated in FIG. 12. Further, the processor 10 acquires next step face rectangle coordinates on the diagonal line L. That is, in step S135, since the apex moving distance for each movement interval is already acquired, the processor 10 acquires, as next step face rectangle coordinates, the position shifted on the diagonal line L from the face rectangle coordinates in the current time interval by the apex moving distance for each movement interval from the apex of the target rectangle. In FIG. 12, the apex moving distance for each movement interval is denoted as distance ΔL, and the next step face rectangle coordinates when the face rectangle coordinates Cₜ₁ in the current time interval are denoted as coordinates Cₜ₁₁.

Once next step face rectangle coordinates are acquired as described above, a moving process or a scaling process is performed in step S215 or S220. The second embodiment is different from the first embodiment in the process before the face rectangle is moved to the center of the frame. The process after the face rectangle is moved to the center of the frame is the same as that of the first embodiment.

In the second embodiment, before the face rectangle is moved to the center of the frame, a moving process and a scaling process are performed at the same time. That is, while the processor 10 adjusts the face rectangle coordinates to match the next step face rectangle coordinates in step S215, all the apexes of the face rectangle are not shifted in accordance with the same vector, but all the apexes of the face rectangle are moved and scaled up in accordance with different vectors.

Various processes may be employed for the above process. For example, a vector can be determined by a process in which a face rectangle whose apex is located on a line connecting the apex of the face rectangle to the apex of the target rectangle is determined as a next step face rectangle. FIG. 13 illustrates an example of such a process. That is, lines L₁, L₂, and L₃ illustrated in FIG. 13 are lines connecting apexes of the face rectangle Rf to the corresponding apexes of the target rectangle Rt.

When next step face rectangle coordinates are coordinates C_{f11}, the processor 10 acquires, as next step face rectangle coordinates C_{f12} and C_{f13}, points at which lines extended in the vertical and horizontal directions from the coordinates C_{f11} intersect with other lines L₂ and L₃. The processor 10 then acquires a rectangle whose apexes are the face rectangle coordinates C_{f11}, C_{f12}, and C_{f13} as a next step face rectangle Rf₁₁.

When the next step face rectangle Rf₁₁ is acquired, the processor 10 determines a scaling rate so that the next step face rectangle Rf₁₁ acquired in step S205 forms new face rectangle coordinates and then performs a scaling process. Further, the processor 10 determines the position of the picture so that the position of the face rectangle in the scaled-up picture matches the face rectangle Rf₁₁ illustrated in FIG. 13 and then displays the picture on the touchscreen 13a. According to such a configuration, a face portion can be moved while scaled up in response to a pinch operation with the aspect ratio of a face rectangle being fixed.

As a result, according to the second embodiment, a moving process and a scaling process are performed at the same time. According to the configuration described above, since scaling up is performed along with motion in response to a pinch-out operation, scaling up expected intuitively from the pinch-out operation is performed, and a natural operation is realized. Further, in the second embodiment, since a scaling process is performed with a target rectangle inscribed in the frame being a target, a picture can be scaled with respect to the frame as a reference. Note that, in the second embodiment, step S210, step S225, and step S230 are the same as those of the first embodiment.

### (5) Other Embodiments

Each of the embodiments described above is an example for implementing the invention, and other various embodiments can be employed. For example, the picture processing device may be embedded in an apparatus other than a camera or may be implemented by a general purpose computer such as a tablet terminal, a smartphone terminal, or the like. Furthermore, a scheme of performing a moving process of moving a picture to the center of the frame in response to a pinch operation and a scaling process of changing the size of a picture while maintain a face portion to the center of the frame as described in the above embodiments can be implemented as the invention of a program, the invention of a method, or the invention of a production method of picture data.

The function of each unit recited in the claims may be implemented by using a hardware resource whose function is identified by the configuration thereof, a hardware resource whose function is identified by a program, or a combination thereof. Further, the function of each unit is not limited to that implemented by hardware resources physically separated from each other.

Furthermore, each of the embodiments described above is an example, and it is possible to omit some of the components, add other components, or replace a component. For example, while a face portion is moved to the center of the frame in both of a pinch-out operation and a pinch-in operation in the embodiments described above, a process of moving a face portion to the center of the frame in one of the pinch-out operation and the pinch-in operation, for example, only the pinch-out operation may be performed. Further, without a use of a touchscreen, an operation other than a pinch operation, such as a button selection may be used to scale up or scale down a picture displayed on a display or a screen.

Further, for example, in step S210 illustrated in FIG. 3 described above, it may be determined whether or not a face portion is moved to the center of the frame, for example, it may be determined whether or not the center of a face rectangle matches the center of the frame. Further, the picture may be moved along a line connecting the center of a face rectangle to the center of the frame when a moving process is performed on a picture in step S215 may be employed. Furthermore, in the first embodiment described above, the apex moving distance in step S220, if performed, may be shorter than the apex moving distance in another step (S215). Accordingly, the processor 10 may re-calculate the apex moving distance so as to have an even apex moving distance over a plurality of movement intervals and performs a moving process in accordance with the re-calculated apex moving distance.

The apex moving distance is calculated per unit time in response to a pinch operation during the unit time and a moving process or a scaling process is performed in a plurality of divided movement intervals as described in the above embodiments as an example, and a moving process or a scaling process may be performed by using other schemes. For example, the pinch-out speed may be measured in a stepwise manner, and moving or scaling in accordance with the speed may be performed in the next step.

Furthermore, a plurality of regions to be targets of a moving process and a scaling process may be provided. For example, a plurality of target rectangles having different sizes may be prepared in advance, a target rectangle may be selected as a target in ascending order of size, and scaling may be performed in a stepwise manner (moving may be included). Such a configuration enables finer control in the process of scaling. When a portion to be scaled up is not a rectangle, a target region may not be a rectangle.

Furthermore, a target region to be a target of a moving process and a scaling process is not limited to the example as described above in the second embodiment, and various regions may be possible. For example, a rectangle circumscribed to a rectangle including a face portion may be a target rectangle and determined as a target region. According to such a configuration, a picture can be scaled with respect to a rectangle including a face portion as a reference. A target rectangle circumscribed to a rectangle including a face portion may be determined by various schemes. For example, a rectangle which is the smallest rectangle in contact with one side of the initial face rectangle and whose center matches the center of the frame may be defined as target rectangle.

Furthermore, picture data on which a moving process and a scaling process has been performed may be utilized in various ways other than quality confirmation of the picture. For example, the processor 10 may use the function of the picture processing unit 10c to perform a cutout process of cutting out an image in a frame obtained after a process in response to a pinch operation is performed. According to such a configuration, it is possible to cut out a picture displayed on the touchscreen 13a after a size change and utilize the cut out picture as picture data. For example, the invention may be applied to the printing device, a face portion may be cut out from a picture read from a removable memory attached to the printing device, and the cut out image may be printed as a picture used for identification. Alternatively, another image such as a frame image may be combined to an image in the frame on which a process in response to a pinch operation has been performed. According to such a configuration, by using a frame defined in association with a frame image to perform a moving process and a scaling process and then performing combination, it is possible to produce image data on which combination is performed easily at a preferable arrangement.

The acquisition unit may be any unit that can acquire a picture. That is, the acquisition unit may be any unit that can acquire a picture including a face portion to be an object of a moving process or a scaling process. For example, an image capturing mechanism that captures a picture may be considered as the acquisition unit. A circuit that reads a picture stored in any type of storage medium may be considered as the acquisition unit, and the storage medium may be provided in the picture processing device or may be provided in the device located outside the picture processing device.

The recognition unit may be any unit that can recognize a face from a picture. That is, the recognition unit may be any unit in which, when a portion estimated as a face is included in a picture, the portion can be identified. Various schemes may be employed for the scheme for recognizing a face, and various schemes other than a scheme using pattern matching may be employed. For example, a scheme of recognizing a face in accordance with a feature amount of an image of a picture may be employed, a scheme of utilizing a neural network may be employed, or a scheme combining a plurality of schemes may be employed. Further, without being limited to identify a face position by using a rectangle in recognition of a face, other shapes such as a circle may be used for identification.

A face may be a part of a head of an animal, and the face may be a face of a human or a face of other types of animals. That is, a face portion may be centered to the center of the frame, or a face may be recognized as a part as a reference to be scaled. When multiple faces are recognized, a face portion to be an object of a moving process or a scaling process may be identified by a touch position at the start of a pinch operation or may be identified by using other schemes. The former may include, for example, a configuration in which a face portion having the largest area included in a rectangle indicated by a touch position or a face portion closest to a touch position is to be an object to be processed. The latter may include, for example, a configuration in which a face portion designated by the user's tap operation or the like or a face portion closest to the center of the frame is to be an object to be processed.

The touchscreen may be any touchscreen that can display a picture. That is, the touchscreen may be any touchscreen on which a picture to be an object of moving or scaling is displayed and which can accept a pinch operation for performing a moving instruction or a scaling instruction.

The picture processing unit may be any unit that can perform a moving process of moving a face portion to the center of the frame in response to a pinch operation and a scaling process of changing the size of the picture while maintaining the face portion at the center of the frame in response to a pinch operation on the moved picture when the pinch operation is performed on a picture displayed on a touchscreen. That is, the picture processing unit may be any unit that can perform at least two types of process such as the moving process and the scaling process in response to a single type of operation such as a pinch operation.

The process performed in response to a pinch operation is not limited to the moving process and the scaling process, more processes may be performed, and the timings when the moving process and the scaling process are performed may be the same as or different from each other. Further, a pinch operation for performing moving and scaling of a face portion may be a touch operation of increasing the distance between at least two touch positions.

The frame used for defining the center that is a target to which a face portion is moved by a moving process may be various frames. For example, the outer circumference of the display range in which a picture is displayed may be the frame, the effective display range of a touchscreen may be the frame, or the outer circumference of a picture may be the frame. The size or the shape of a frame is not particularly limited. For example, when printed for a picture used for identification, the frame may have a size and a shape required for a type of picture used for identification desired by the user. Further, when a picture is combined to a different image such as a frame image, a frame may be defined in association with such a different image. Further, when a plurality of windows are displayed on a touchscreen, a window in which a picture is displayed may be the frame, or the user may designate a frame.

The moving process may be any process that can move a face portion to the center of the frame. The position of a face portion to be matched to the center of the frame may be various positions, and the position may be the center of a rectangle circumscribed to a face portion or a point on the rectangle or may be a position corresponding to a particular part of a face (for example, an eye or eyes, a nose, or the like).

The scaling process may be any process that can change the size of a picture moved to the center of the frame while maintaining the face portion at the center of the frame. That is, after a face portion is moved to the center of the frame, the size of the face portion may be at least changed without shifting the face portion. Therefore, a change of size may be started before the face portion is moved to the center of the frame, or change of size may be started after the face portion is moved to the center of the frame.

It is possible to perform image processing such as brightness change other than scaling or moving using a face portion before or after the scaling or moving is performed. Further, fine adjustment desired by the user may be enabled by performing normal scaling or moving without using a face portion after the scaling or moving using the face portion.

Note that the center of the frame in the invention refers to the center located on the frame or within the frame with respect to a portion on which scaling process is performed. While the frame is a rectangle and thus the center of the frame corresponds to the centroid of the frame in the present embodiment, the embodiment is not limited thereto. For example, the frame may be a circle, or the center may be located on the frame. However, it is desirable to determine a position of the center of the frame and a position of a face portion to be matched to the center of the frame so that the face portion is not out of the frame as much as possible even after scaling is performed. For example, when each of a face portion and a frame is taken with a rectangle, it is preferable to have the same center on the bottom sides of the rectangles and define the center of the bottom side of the frame as the center of the frame.

What is claimed is:

1. A picture processing device comprising:
an acquisition unit that acquires a picture;
a recognition unit that recognizes a face portion from the picture;
a display unit that displays the picture; and
a picture processing unit that, when a scale-up instruction to perform a scale-up process on the picture displayed on the display unit is received, performs a moving process of moving the face portion to the center of a frame in response to the scale-up instruction and a scaling process of changing picture size while maintaining the face portion at the center of the frame in response to the scale-up instruction to perform a scale-up process on the moved picture.

2. The picture processing device according to claim 1, wherein, in the moving process, the picture processing unit moves the face portion to the center of the frame in response to the scale-up instruction while maintaining the picture size.

3. The picture processing device according to claim 1, wherein, in the moving process, the picture processing unit moves the face portion to a target region whose center matches the center of the frame while changing the face portion size.

4. The picture processing device according to claim 3, wherein the target region is inscribed in the frame.

5. The picture processing device according to claim 3, wherein the target region is circumscribed on a rectangle including the face portion.

6. The picture processing device according to claim 1, wherein a difference between a region of the face portion obtained before a change of the picture size and a region obtained in accordance with a distance of the scale-up instruction is divided into a predetermined number of movement intervals, and the picture size is changed in a stepwise manner.

7. The picture processing device according to claim 1, wherein the picture processing unit performs a cutout process of cutting out an image in the frame on which a process caused by the scale-up instruction has been performed.

8. The picture processing device according to claim 1,
wherein the display unit is a touchscreen,
wherein the scale-up instruction corresponds to a pinch-out operation,
wherein when a plurality of faces are recognized from the picture, the recognition unit selects one of the faces in accordance with a start position of the pinch-out operation, and
wherein the picture processing unit performs a moving process of moving an image of the selected face and a scaling process of changing the picture size while maintaining a position of the image of the selected face.

9. A method of producing picture data, the method comprising:
acquiring a picture;
recognizing a face portion from the picture; and
when a scale-up instruction to perform a scale-up process on the picture displayed on a display unit is received, producing picture data by performing a moving process of moving the face portion to the center of a frame in response to the scale-up instruction and a scaling process of changing the picture size while maintaining the face portion at the center of the frame in response to the scale-up instruction to perform a scale-up process on the moved picture.

10. A non-transitory storage medium that stores a picture processing program that causes a computer to function as
an acquisition unit that acquires a picture;
a recognition unit that recognizes a face portion from the picture; and
a picture processing unit that, when a scale-up instruction to perform a scale-up process on a picture displayed on the display unit is received, performs a moving process of moving the face portion to the center of a frame in response to the scale-up instruction and a scaling process of changing the picture size while maintaining the face portion at the center of the frame in response to the scale-up instruction to perform a scale-up process on the moved picture.
